(19) United States
(12) Patent Application Publication
(10) Pub. No.: US 2024/0335013 A1
(43) Pub. Date: Oct. 10, 2024

(54) SUPPORT FOR A TIMEPIECE OR ITEM OF JEWELLERY COMPRISING THE SUPPORT AND A DECORATIVE INSERT

(71) Applicant: Rolex SA, Genève 26 (CH)

(72) Inventors: Daniel LOPEZ, CHÊNE-BOURG (CH); Guillaume REI, CRASSIER (CH)

(21) Appl. No.: 18/627,215

(22) Filed: Apr. 4, 2024

(30) Foreign Application Priority Data
Apr. 6, 2023 (EP) 23166956.5

(51) Int. Cl. A44C 17/02; A44C 17/04

(52) U.S. Cl. CPC A44C 17/02; A44C 17/043

(57) ABSTRACT

The invention relates to a support for a timepiece or item of jewellery, the timepiece or item of jewellery comprising the support and a decorative insert crimped on the support, the support comprising:
a front face,
a rear face,
at least one through housing intended to receive the decorative insert, comprising:
an exposure opening provided on the front face in order to make the decorative insert visible to an observer,
an insertion opening provided on the rear face in order to introduce the decorative insert into the through housing,
a mount intended for positioning the decorative insert,
   characterised in that the support comprises a portion to be crimped intended to be plastically deformed on the decorative insert positioned against the mount, in order to produce a crimp of the decorative insert.

### FIELD OF THE INVENTION

The present invention relates, in general, to watchmaking or jewellery, and in particular the present invention relates to supports for timepieces or items of jewellery intended to receive a decorative element such as a decorative insert, a precious, semiprecious or ornamental stone, a gemstone or any other added decorative piece. Such a support may be called a bezel and the decorative element can be crimped on the support.

### PRIOR ART

Document U.S. Pat. No. 1,092,587A is known in the prior art for timepieces or items of jewellery, and discloses a support with a tab to be folded down on a pavilion of a gemstone to be crimped. On the other hand, this system can have disadvantages, such as concealing the pavilion, which can affect the brilliance. It should also be noted that the tab to be folded down must not have any springback, or else the gemstone could be poorly crimped and move. It is therefore necessary to choose a highly ductile material with the lowest possible elastic deformation. It should also be noted that the manufacturing method requires starting from a sheet metal, which may limit the shapes of the support.

### DISCLOSURE OF THE INVENTION

An aim of the present invention is to respond to the above-mentioned disadvantages of the prior art and, in particular, firstly to propose a support for a decorative insert which is easy to manufacture, and/or affects the brilliance of the decorative insert as little as possible, and/or which ensures an optimum repeatability of the position and orientation of the decorative insert within the support, and/or which ensures a high quality of crimping, in other words with a robust and/or aesthetic fixing of the decorative insert on the support.

For this purpose, a first aspect of the invention relates to a support for a timepiece or item of jewellery, comprising the support and a decorative insert, such as a gemstone, crimped on the support, the support comprising:
a front face, arranged to be visible for a user,
a rear face,
at least one through housing (or through-hole) arranged between the front face and the rear face and intended to receive the decorative insert, comprising:
an exposure opening provided or arranged or opening on the front face in order to make the decorative insert visible to the observer,
an insertion opening provided or arranged or opening on the rear face in order to introduce the decorative insert into the through housing,
a mount intended for positioning the decorative insert in the through housing, characterised in that the support comprises a portion to be crimped, preferably from the rear face, intended to be plastically deformed on the decorative insert positioned against the mount, in order to produce a crimp of the decorative insert.
   The portion to be crimped is intended to be plastically deformed on the decorative insert, in other words irreversibly deformed, so that the fixing of the decorative insert on the support is reliable and robust; there is no risk of relative movement between the support and the decorative insert. It should likewise be noted that the portion to be crimped is arranged on the rear-face side, so that the user will not see it, and the appearance of the front face is independent of the portion to be crimped and of the crimping carried out, which provides a great freedom of design and/or decoration.

According to an embodiment, the portion to be crimped can be arranged between the exposure opening and the insertion opening. According to an embodiment, the portion to be crimped can be arranged at the periphery or around the mount and/or the decorative insert.

According to an embodiment, the support can comprise a bearing surface arranged on the rear-face side and intended to provide an end-of-crimping bearing for a crimping tool intended to deform the portion to be crimped on the decorative insert. The bearing surface can act as a crimping end-of-travel abutment, which enables the forces applied to the decorative insert to be better controlled. More specifically, at the end-of-travel, it is the support itself which directly takes up the forces applied by the crimping tool, via the bearing surface, and these forces do not pass through the decorative insert. Such an implementation also makes it possible to guarantee the chain of dimensions, by reducing the geometric dispersions, since the bearing surface and the portion to be crimped are provided on a same and single part, namely the support. In other words, the invention may relate to the use of a bearing surface for determining a crimping dimension or a crimping travel. Such a use of a bearing surface requires a particular dimensioning and/or tolerance between the bearing surface and the mount of the decorative insert. In particular, the bearing surface is not a simple rear surface of the support, it is a surface dedicated to the abutment function of the crimping tool. According to an embodiment, the bearing surface is distinct or different from the portion to be crimped. In particular, the bearing surface is distinct or different from the portion to be crimped before or after crimping. The bearing surface does not undergo any crimping deformation.

According to an embodiment, the bearing surface can be arranged so as to be hidden from the user. Typically, since the portion to be crimped is accessible from the rear face, the bearing surface is advantageously intended to be invisible for the user. In particular, it is understood that the crimping tool does not come into contact with the front face. Thus the front face does not undergo any deformation or matting.

According to an embodiment, the bearing surface can be arranged at the periphery of the portion to be crimped, and preferably around the portion to be crimped.

According to an embodiment, the portion to be crimped may comprise a lip comprising a preferably cylindrical central face, and a preferably conical or frustoconical outer face, adjacent to the bearing surface. According to an embodiment, the lip can be formed or present on the support before the introduction of the decorative insert into the through housing. In other words, the support is manufactured (machined, moulded, etc.) with the lip and the through housing, and the decorative insert is then introduced into the through housing. According to this embodiment, the pre-existing lip is deformed after the introduction of the decorative insert into the through housing.

According to an embodiment, the bearing surface can be arranged on the rear face. According to an embodiment, the rear face forming the bearing surface is distinct, and/or separate and/or arranged at a distance from the portion to be crimped and/or the mount.

According to an embodiment, the front face may comprise a decorated surface intended to be visible to the user and able to comprise a decorative finish or a decorative termination, such as a surface coating, diamond plating, polishing, or engraving. The decorated surface is therefore situated opposite the insertion opening and the portion to be crimped, the decorated surface is not exposed to the crimping tool, and specific terminations can be provided and/or it can be ensured that the appearance of the decorated surface is not affected by the crimping of the portion to be crimped. In any event, once the crimping has been carried out, it is not necessary to provide a termination operation on the front face.

According to an embodiment, in a crimping direction and in a plane normal to the crimping direction:
the bearing surface can have a first projected surface,
the front face (in other words the decorated surface) can have a second projected surface,
   and the area of the second projected surface can be greater than the area of the first projected surface, preferably the area of the second projected surface can be greater than 150% of the value of the area of the first projected surface, and preferably the area of the second projected surface can be greater than 200% of the value of the area of the first projected surface. According to the implementation above, the decorated surface can be notably larger than the bearing surface, so that the contact pressure or Hertz pressure (at the crimping end-of-travel, on the one hand between the crimping tool and the bearing surface and, on the other hand, between the decorated surface and a holder) will be higher on the side of the bearing surface. Consequently, any potential marking caused by a crimping force will take place on the side of the bearing surface, and the decorated surface will remain unmarked.

According to an embodiment, the crimped of the decorative insert can be a bezel crimp. Such a crimp totally surrounds the decorative insert with a lip or a fine thickness of material, without concealing, or without significantly concealing, the rear part of the decorative insert (for example the pavilion of a gemstone), so that the brilliance is little affected. In such an embodiment, the portion to be crimped is a continuous portion (for example a lip) which surrounds the mount. The crimping forces are therefore distributed over the entire periphery of the decorative insert, which reduces the risk of damage, in particular with respect to a grain crimp or a claw crimp. Likewise, a pre-existing lip can reduce the crimping force, in particular with respect to solutions where the portion to be crimped is cut into the support by the crimping tool. It should be noted that the solution can simplify the crimping while ensuring a better resistance or mechanical strength, in particular with respect to a grain crimp or claw crimp. The solution also ensures a precise orientation and positioning, that is reproducible and repeatable, of the decorative insert within the through housing of the support.

According to an embodiment, the portion to be crimped can comprise a lip arranged at the periphery of the mount and intended to be completely or partially folded down on the decorative insert. Such a lip to be folded down enables simple crimping with a simple crimping tool. According to an embodiment, the lip can be formed or present on the support before the introduction of the decorative insert into the through housing. In other words, the support is manufactured (machined, moulded, etc.) with the lip and the through housing, and the decorative insert is then introduced into the through housing. According to this embodiment, the pre-existing lip is deformed after the introduction of the decorative insert into the through housing.

According to an embodiment, the lip can comprise recesses or slots. Such an implementation provides a great freedom of design and/or manufacture. The crimping forces can be reduced.

According to an embodiment, the portion to be crimped can comprise a plurality of deformable portions in the form of petals, arranged at the periphery of the mount and intended to be folded down onto the decorative insert. The crimping forces can be reduced.

According to an embodiment, once folded down onto the decorative insert, at least two adjacent deformable portions (for example petals) of the plurality of deformable portions can be at least partially contiguous. The appearance at the end of crimping is of high quality.

According to an embodiment, the portion to be crimped can comprise at least one side wall portion of the through housing to be pushed back and/or sheared by the crimping tool. In such a case, the crimping tool can shear and/or incise the material of the through housing in order to press it and/or fold it down onto the decorative insert.

According to an embodiment, the decorative insert can comprise a rear undercut part intended to be arranged on the rear-face side, and the portion to be crimped can be intended to be crimped against the rear undercut part.

According to an embodiment, the support can comprise at least one centring surface, intended to centre the decorative insert on the exposure opening. Such a centring surface can improve the perceived quality by providing a precise positioning between the support (its decorated surface, its outer periphery) and the decorative insert (the crown or the table of a cut gemstone).

According to an embodiment, the decorative insert can comprise a flank, that is for example cylindrical, such as a girdle, and the centring surface can be provided to receive the flank.

According to an embodiment, the portion to be crimped can be arranged between the mount and the insertion opening and/or the rear face.

According to an embodiment, the mount can comprise a contact surface with the decorative insert, which is continuous. The contact surface can be flat, or else conical or frustoconical. A shape that is complementary to that of the decorative insert is possible, in order to have a surface contact between the support and the decorative insert, in order to avoid any concentration of stresses on the decorative insert.

According to an embodiment, the mount can comprise a contact surface with the decorative insert, which is discontinuous. It is possible to provide slots that are clear spaces in order, for example, to release the decorative insert of the support in order to maximise the passage of light, the visibility or the exposure of the decorative insert.

A second aspect of the invention can relate to a timepiece or item of jewellery, comprising:
at least one support according to the first aspect, and
at least one decorative insert arranged in the through housing against the mount, the portion to be crimped being crimped or folded down onto the decorative insert.

A third aspect of the invention can relate to a manufacturing method for a timepiece or item of jewellery, comprising the following steps:
providing a support according to the first aspect,
optionally, placing the front face of the support on a crimping holder, it being understood that the front face may be coated or protected by a part or an intermediate coating,
introducing a decorative insert into the through housing via the insertion opening,
plastically deforming the portion to be crimped against the decorative insert.

According to an embodiment, the step of plastically deforming the portion to be crimped can be carried out by introducing a crimping tool into the through housing via the insertion opening, the crimping tool being able to comprise a crimping interface intended to come into contact with the portion to be crimped and for plastically deforming the portion to be crimped.

According to an embodiment, the step of plastically deforming the portion to be crimped can be terminated by a mechanical abutment of the crimping tool on the support. In other words, the deformation step comprises a final step of abutment of the crimping tool. According to this embodiment, the crimping tool can comprise an abutment surface, for example a shouldered surface, intended to come into abutment with the support in order to define the end of travel for crimping. According to this embodiment, the abutment surface is distinct and/or separate and/or arranged at a distance from the crimping interface. Consequently, the crimping interface and the abutment surface are intended to ensure a sufficient deformation of the portion to be crimped.

According to an embodiment, the crimping tool can comprise a contact interface intended to cooperate with the decorative insert, and the manufacturing method can comprise a step consisting of positioning the decorative insert relative to the support with the contact interface, at least before or during the step of plastic deformation of the portion to be crimped. Typically, the contact interface can be floating with respect to a work portion (the crimping interface) of the tool intended to fold down the portion to be crimped. Hence, the contact interface can come into contact with the decorative element before the remainder of the crimping tool, in order to centre the decorative element, and the contact interface can then slide with respect to the remainder of the crimping tool, during the crimping operation.

According to an embodiment, the contact interface can be intended to carry out a gripping of the decorative insert, the manufacturing method comprising a step of gripping of the decorative insert by the crimping tool, and the step of inserting the decorative insert into the through housing can be carried out by the crimping tool. It is also possible to position the decorative insert on the contact interface, by holding it in place, for example by suction, in order to then automatically perform the insertion in the support.

According to an embodiment, the manufacturing method can comprise a step of relative movement between the contact interface and the crimping interface, at least during the step of plastically deforming the portion to be crimped.

According to an embodiment, the crimping tool can follow a linear movement, preferably coaxial to an axial direction of the through housing.

According to an embodiment, the step of deforming the portion to be crimped can be carried out in a single action and/or a single movement of the crimping tool.

According to an embodiment, the crimping interface can comprise recesses, clear spaces or portions beyond the reach of the portion to be crimped, and the step of plastically deforming the portion to be crimped can be carried out, along the portion to be crimped, with heterogeneous or discontinuous deformation of the portion to be crimped.

A fourth aspect of the invention can relate to a crimping tooling, provided for implementing the manufacturing method according to the third aspect, comprising:
a crimping holder intended to receive the support according to the first aspect,
a crimping tool comprising:
a crimping interface intended to come into contact with the portion to be crimped of the support according to the first aspect and in order to plastically deform the portion to be crimped,
a contact interface, movable relative to the crimping interface and intended to receive and hold the decorative insert on the crimping tool before a crimping operation,
   wherein the crimping tool has an internal clear space intended to avoid any direct contact between the crimping interface of the crimping tool and the decorative insert.

According to an embodiment, the crimping tool can comprise a contact interface intended to cooperate with the decorative insert and to position the latter relative to the support, at least during the plastic deformation of the portion to be crimped, and wherein the contact interface can be movable, for example by flowing, relative to the crimping interface.

A fifth aspect of the invention can relate to a crimping kit comprising a crimping tool, at least one support and at least one decorative insert to be crimped in said at least one support.

According to an embodiment, the support comprises:
a front face, arranged to be visible for a user,
a rear face,
at least one through housing arranged between the front face and the rear face and intended to receive the decorative insert, comprising:
an exposure opening provided or arranged or opening on the front face in order to make the decorative insert visible to the observer,
an insertion opening provided or arranged or opening on the rear face in order to introduce the decorative insert into the through housing,
a mount intended for positioning the decorative insert in the through housing,
   the support comprising a portion to be crimped, preferably from the rear face, formed for example by a crimping lip, that is for example continuous, and intended to be plastically deformed on the decorative insert positioned against the mount. According to an embodiment, the support comprises a bearing surface provided to form an end-of-crimping abutment for the crimping tool. According to an embodiment, the crimping tool comprises an abutment surface, for example a shoulder, intended to abut against the bearing surface at the end of crimping. Such a crimping kit can guarantee a reproducible and repeatable crimping, without risk of damaging or moving the decorative insert during crimping.

### DESCRIPTION OF THE FIGURES

Other features and advantages of the present invention will become more clearly apparent on reading the following detailed description of an embodiment of the invention, given by way of not-limiting example, and illustrated by the appended drawings, in which:

FIG. 1 shows a sectional view of a support according to the present invention;

FIG. 2 shows a side view of a decorative insert that can be received in the support of FIG. 1;

FIG. 3 shows the decorative insert of FIG. 2 received in the support of FIG. 1;

FIG. 4 shows the assembly of FIG. 3 positioned in a crimping tool, before a crimping operation to fix the decorative insert of FIG. 2 received in the support of FIG. 1;

FIG. 5 shows the assembly of FIG. 3 positioned in the crimping tool after a crimping operation;

FIG. 6 shows the assembly of FIG. 3 after the crimping operation;

FIG. 7 shows a perspective view, from the front, of the assembly of FIG. 3 after the crimping operation;

FIG. 8 shows a perspective view from behind of the assembly of FIG. 3 after the crimping operation.

### DETAILED DESCRIPTION OF AN EMBODIMENT

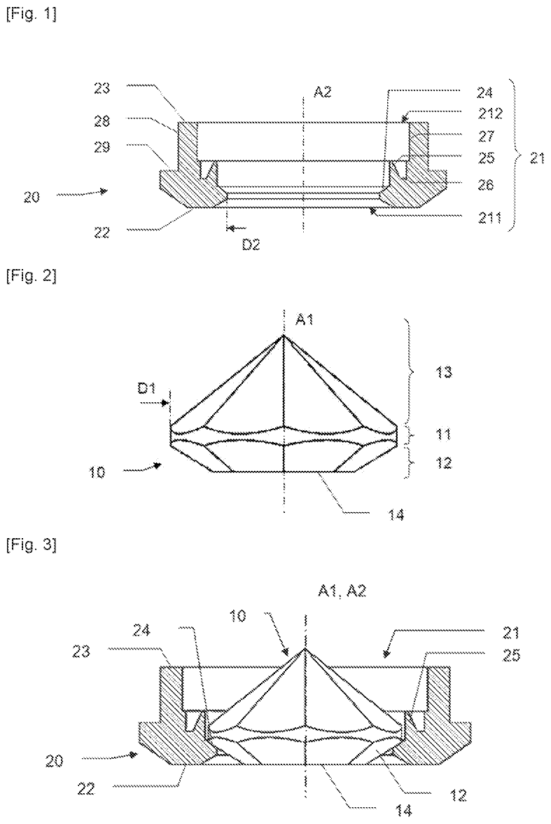

The present invention relates to a support 20 (FIG. 1) intended to receive a decorative insert 10 (FIG. 2), in order to form a decorative assembly that can be incorporated in a timepiece or item of jewellery. The decorative insert 10 is preferably a gemstone 10 or a cut precious stone 10 that can be of any shape. The support 20 can be a bezel, a dial, a middle, a metal bracelet link or any other jewellery or watchmaking component that can accommodate a stone. The support 20 is preferably made of a ductile material such as gold, platinum, brass or steel. FIG. 1 shows a sectional view of a support 20 intended to receive and fix a decorative insert 10 shown in FIG. 2.

The support 20 of FIG. 1 comprises, in particular:
a front face 22, arranged to be visible for a user,
a rear face 23, arranged opposite the front face 22,
a through housing 21 arranged between the front face 22 and the rear face 23 and intended to receive and centre the decorative insert 10 in the support 20, comprising:
an exposure opening 211 provided on the front face 22 in order to make the decorative insert 10 visible to the observer,
an insertion opening 212 provided on the rear face 23 in order to introduce the decorative insert 10 into the through housing 21,
a mount 24 intended for position the decorative insert 10 in the through housing 21,
a portion to be crimped 25, accessible to a crimping tool from the rear face 23 via a clear space 27 and intended to be plastically deformed on the decorative insert 10 positioned against the mount 24, for producing a crimp of the decorative insert 10
an outer portion 28, in particular cylindrical, provided on the rear-face side 23,
a mount 29 adjoining the outer portion 28 in order to define an axial abutment of the assembly of the support 20 on a timepiece or item of jewellery.

The front face 22, which is intended to be visible by an observer or a user, can be provided with a decorative finish, such as polishing (a mirror polish), decorative engravings, chamfers or decorative rays constituting a sunburst. There is no limit to the geometric definition of the front face 22 forming the visible portion of the support 20. Preferably, the front face 22 adopts a geometry comprising, for example, chamfers or facets giving value to the decorative insert 10. The finish of the front face 22 can advantageously be, in particular, diamond plating, black polish or mirror polish. Finishes such as satin finishing, sunburst, snailing, guillochs or any other watchmaking finish can also be applied independently on the various surfaces of the front face 22. In addition, marks or engravings produced, for example, by laser, can also be applied. Coloured deposits can also be applied such as ink, enamel, ceramic or luminescent material.

The rear face 23 may be intended to be hidden from the observer or from the final user, but, the opposite is possible, in other words the rear face 23 can be left visible.

The mount 24 is therefore arranged between the exposure opening 211 and the insertion opening 212, and has a conical or frustoconical surface, in order to properly centre the decorative insert 10. The mount 24 opening has a diameter D2, which is the smallest passage diameter of the through housing 21.

The portion to be crimped 25 overhangs the mount 24 on the insertion-opening side 212 and, in this example, forms a lip having a central cylindrical recess central and a conical or frustoconical outer face which opens onto a bearing surface 26 (in other words, the crimping lip or at least its outer surface is adjacent to the bearing surface 26). The bearing surface 26 itself forms the bottom of the clear space 27. The clear space 27 opens directly on the rear face 23, and can provide a passage for a crimping tool, as will be described below. As shown in FIG. 1, the portion to be crimped 25 has a cross-section which reduces towards its free end.

At the mount 24 and/or at the portion to be crimped 25, shapes or counter shapes can be seen for angularly orienting the decorative insert 10. In particular, if the bare decorative insert 10 has, when viewed from above, a non-circular size, silhouette or shape (oval, pear-shaped, baguette-shaped, polygonal size, shape or silhouette, etc.), then the mount 24 and/or the portion to be crimped can have a receiving counter shape suitable for ensuring a precise and reliable angular orientation.

The support 20 has a central axis A2 central, which here forms an axis of symmetry of the through housing 21.

FIG. 2 shows a side view of the decorative insert 10 which can be received in the support 20 of FIG. 1. The decorative insert 10 can be a precious stone which comprises a crown 12 defined by the lower part (with reference to FIG. 2) of the stone and a pavilion 13 defined by the upper part (with reference to FIG. 2). The two parts are separated by a girdle 11 of diameter D1, which defines the contour or the peripheral edge of the stone. In addition, the stone comprises a table 14 defined by the large lower facet of the stone, at the centre of the crown 12. Finally, the decorative insert 10 as an axis A1 passing through its centre and perpendicular to the table 14.

FIG. 3 shows the decorative insert 10 of FIG. 2 received in the support 20 of FIG. 1. Within the decorative assembly thus presented, the crown 12 is the front or visible part of the decorative insert 10, and the pavilion 13 is the rear or hidden part of the decorative insert 10.

The decorative insert 10 is intended to be placed within the support 20 in order to form an aesthetic decorative assembly of high quality. More particularly, the decorative insert 10 is intended to be placed within the through housing 21 by being inserted from the rear of the support 20, in a direction substantially coaxial to the axis A2 of the support 20. The axis A2 is longitudinal to the through housing 21 and passes through the centre thereof.

The through housing 21 is machined so as to adjust the girdle 11 of the decorative insert 10 and enable optimum positioning thereof. In addition, the mount 24 is provided with an opening with a dimension D2 less than the dimension, in particular the diameter D1, of the girdle 11, in order to correctly retain the decorative insert 10.

The mount 24 of the through housing 21 is intended to cooperate with or adjust to the crown 12, so as to define an axial abutment and precise positioning of the decorative insert 10. More particularly, the mount 24 is defined so as to position the table 14 along the axis A2 with high precision, and to orient the table 14 such that the axis A1 of the decorative insert 10 and the axis A2 of the support 20 are as perfectly coaxial as possible.

The opening defined by the mount 24 is provided so as to allow the appearance of the table 14 and a major portion of the crown 12 on the visible side of the decorative assembly. More specifically, only a small portion situated on the outer circumference of the crown 12 is, preferably, intended to cooperate with the mount 24, in order to allow the largest possible part of the decorative insert 10 to appear.

It should be noted that the decorative insert 10 can be mounted and crimped in the support 20 “in the other direction” with respect to the representation of FIG. 3. More specifically, the pavilion 13 of the decorative insert 10 can be positioned against the mount 24 and the portion to be crimped 25 would match the crown 12. Consequently, it would thus be the pavilion 13 which would be the visible side of the decorative assembly.

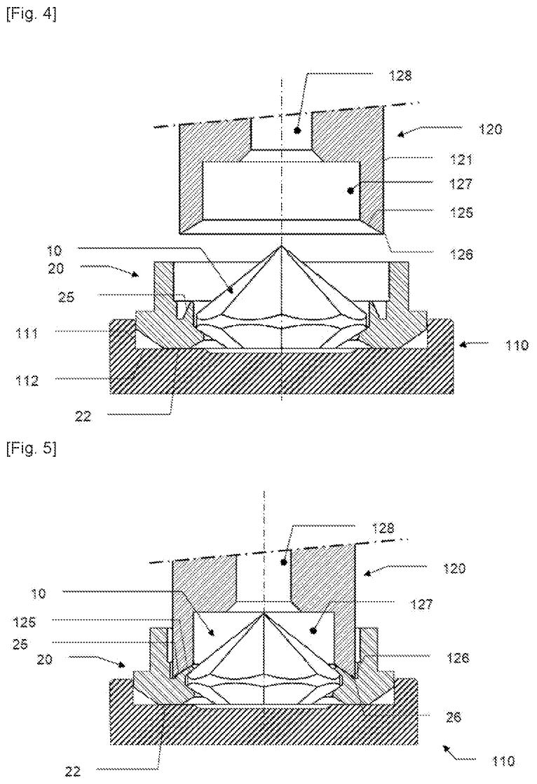

The support 20 comprises a portion to be crimped 25 arranged on the rear side of the support 20, intended to ensure the crimping function of the decorative insert 10. FIG. 4 shows the assembly of FIG. 3 positioned in a crimping tool, before a crimping operation to fix the decorative insert 10 of FIG. 2 received in the support 20 of FIG. 1.

The crimping tool substantially comprises a holder 110 which receives the support 20 (with the decorative insert 10 placed in the support 20), and a crimping tool 120, facing the portion to be crimped 25 of the support 20.

The holder 110 can comprise a bore 111 for properly centring the support 20, and a base surface 112 which receives the front face 22 of the support 20. The base surface 112 can have a recess or a niche facing the table 14, to avoid any interference. Optionally, the base surface 112 can perfectly match the front face 22.

The crimping tool 120 has the shape of a punch with a hollow cylinder 121 having a crimping interface 125 and an inner clear space 127 into which a through passage 128 opens. The crimping interface 125 is directly facing the portion to be crimped 25, and ends with a terminal surface 126 (itself facing the bearing surface 26 of the support 20), at the bottom of the crimping tool 120.

The decorative assembly of FIG. 4 is ready to be crimped, and for this purpose, the crimping tool 120 can perform a downward axial movement in order to go into an end-of-travel position, or end-of-crimping position, as shown in FIG. 5. In FIG. 5, it should be noted that, during its downward movement, the crimping tool 120 comes into contact with the portion to be crimped 25, so that the crimping interface 125 has folded down the portion to be crimped 25 against the decorative insert 10. In detail, the portion to be crimped 25 is folded down on a peripheral part of the pavilion 13, so that a bezel crimp of the decorative insert 10 is produced by the rear of the support 20.

It can be seen that the inner clear space 127 and the through passage 128 of the crimping tool 120 avoid any interference with the decorative insert 10. We can also be seen that the terminal surface 126 of the crimping tool 120 is able to be in contact with the bearing surface 26, so that the deformation of the portion to be crimped 25 is well controlled, and so that any inadvertent crimping force passes directly from the crimping tool 120 to the support 20, and not via the decorative insert 10, which preserves the latter.

It can also be seen that the front face 22 in contact with the holder 110 has a much larger contact area than the bearing surface 26, and/or than the cross-section of the plastically deformed portion to be crimped 25. As a consequence of this large contact area of the front face 22 in contact with the holder 110, the front face 22 undergoes no irreversible deformation and suffers no marks linked to the crimping: the visible appearance of the support 20 and its perceived quality are not affected by the crimping.

The bezel crimping provides an excellent mechanical holding of the stone within the support 20. Moreover, this type of crimping only covers the circumference of the pavilion 13, thus enabling the maximum possible light to pass and hence maximising the brilliance of a transparent stone.

At the level of the bearing of the crimping interface 125 on the portion to be crimped 25, the crimping interface 125 and/or the portion to be crimped 25 advantageously have a conical or frustoconical shape or, more generally, a cross-section with an inclined plane. Advantageously, this configuration causes the axial force applied to the crimping tool 120 to generate a deformation of the portion to be crimped 25 with a mainly radial component relative to the axes A1, A2, so as to match the pavilion 13 and to crimp the decorative insert 10 on the support 20.

Thus, the axial force applied to the crimping tool 120 is not directly transmitted to the decorative insert 10, but is converted into a substantially radial deformation of the lip. In other words, the force applied to the crimping tool 120 is not directly transmitted to the decorative insert 10 with a component mainly normal to the latter, and it does not give rise to a mainly axial force on the decorative insert 10. Advantageously, this makes it possible to avoid damaging or displacing the decorative insert 10 or else causing an unwanted deformation of the support 20 or, more particularly, of the mount 24.

The fact that the circumference of the portion to be crimped 25 is simultaneously deformed can ensure an optimum centring or self-centring of the decorative insert 10 during crimping. Moreover, this fact makes it possible to avoid skewing and to ensure an optimum coaxial relation between the axis A1 of the decorative insert 10 and the axis A2 of the support 20.

The crimping tool 120 comprises an outer portion 121 which adjoins the crimping interface 125 via the outside. The dimensions of the outer portion 121 are such as to allow the insertion of the crimping tool 120 into the clear space 27 of the support 20.

The crimping tool 120 is preferably assembled on a bracket enabling it to be axially guided. The crimping tool 120 can be controlled in terms of position and/or force, and be automatically, semi-automatically or manually operated by a user.

It is intended that the crimping is performed in a single action of the crimping tool 120, i.e. by a single axial movement of the crimping tool 120 against the portion to be crimped 25. Alternatively, the action for shaping the portion to be crimped 25 can comprise a series of axial movements and stops, and may or may not comprise to-and-fro movements of the crimping tool 120. As such, it should be noted that it is possible to take advantage of this movement of the crimping tool 120 in the support 20 in order to provide automatic insertion of the decorative insert 10 into the support. More specifically, a contact or gripping interface can be provided on the crimping tool 120 (movable with respect to the crimping interface 125) which can receive and hold the decorative insert 10 on the crimping tool 120 in a rest position. During the movement of the crimping tool 120 towards the support 20, the decorative insert 10 is transported towards the mount 24 and positioned against the latter, and the portion to be crimped 25 is then deformed.

An axial abutment and/or the control of the crimping tool 120 can advantageously allow the axial movement of the latter to be limited during crimping and prevent excessive deformation of the portion to be crimped 25 and/or of the mount 24 able, in particular, to degrade the positioning or the retention of the decorative insert 10 within the through housing 21.

The support 20 or at least the various parts of the support 20 intended to position, orient and hold the stone are designed so as to be able to be machined using high precision manufacturing means enabling mass production, such as milling or turning. More particularly, at least the through housing 21, the mount 24, the opening defined by the mount 24 and the portion to be crimped 25 are machined using said manufacturing means. Consequently, it is advantageously possible to orient and position the table 14 along the axis A2 in a precise and repeatable manner.

Moreover, through crimping of the decorative insert 10 via the rear and at the mount 24, it is possible to reduce the chain of dimensions between the table 14 and the front face 22 to a minimum of dimensions, which still allows the dispersion or the standard deviation to be limited on, in particular, the positioning of the precious stone along the axis A2.

The precision and repeatability provided by the disclosed solution are particularly advantageous when a plurality of decorative inserts 10 and/or decorative assemblies are assembled side-by-side, because the solution makes it possible to have the assembly of the tables 14 positioned substantially at the same height and to have them substantially all oriented in a same plane with a high precision and/or a low dispersion. The result is a reflection and chatoyancy in unison of all of the decorative inserts 10, as if all of the tables 14 had come from the same material of a same stone.

The disclosed solution therefore enables a crimping of the rear or hidden side of the decorative assembly. Consequently, the aesthetics or finish of the visible side of the decorative assembly is advantageously not dependent on the quality of the implementation of the crimping. More specifically, the solution proposed here enables the crimping function, which is performed on the rear side of the decorative assembly, to be dissociated from the aesthetic function which is performed on the front or visible side thereof.

Moreover, the solution makes it possible to simplify the crimping while guaranteeing a high resistance or mechanical strength and a precise orientation and positioning of the decorative insert 10 within the through housing 21 of the support 20.

With reference to FIGS. 4 and 5, the crimping can comprise the following steps:
providing a support 20 with the front face 22 placed or held against a holder 110.
inserting a decorative insert 10 into the through housing 21 via the insertion opening 212 of the support 20, so that the crown 12 bears against the mount 24.
moving the crimping tool 120 coaxially to the axis A2 until it is in contact with the portion to be crimped 25.
crimping the decorative insert 10 on the support 20 by applying a sufficient force to the crimping tool 120, which enables the portion to be crimped 25 to be folded down against the pavilion 13. As previously described, this step can comprise a series of axial movements and stops, and may or may not comprise to-and-fro movements.
stopping the application of the force once it has reached a setpoint value and/or once the movement of the crimping tool 120 has reached a setpoint value and/or once the crimping tool 120 is in abutment against the bearing surface 26 of the support 20.
placing the crimping tool 120 out of reach of the decorative assembly.

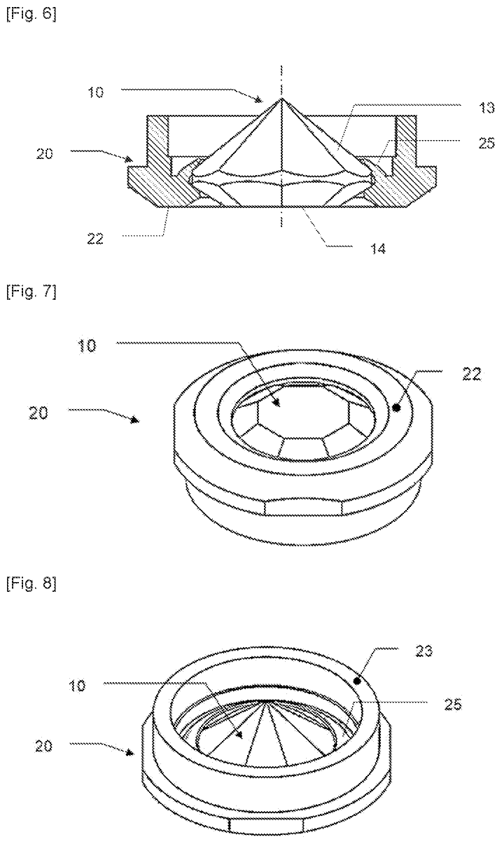

FIG. 6 shows the assembly of FIG. 3 after the crimping operation of FIG. 5. It can be seen that the portion to be crimped 25 is correctly folded down on the peripheral part of the pavilion 13, with the table 14 perfectly aligned with the front face 22 of the support 20.

FIG. 7 shows a perspective view from the front of the assembly of FIG. 3 after the crimping operation, to clearly show that the support 20 leaves a large part of the decorative insert 10 visible. It can be seen that the front face 22, having a large contact area with the holder 110 of FIG. 4 or 5, is free from marks.

FIG. 8 shows a perspective rear view of the assembly of FIG. 3 after the crimping operation, to clearly show the portion to be crimped 26 folded down all around the decorative insert 10, thus forming a bezel crimp.

Once the crimp is produced, the user, who will look at the decorative assembly from the front face 22, as shown in FIG. 7, would consider that the decorative insert 10 is fixed on the support 20 by a bezel crimp or a flush crimp performed from the front face 22. This front face has an appearance which is not altered by the crimping, the notion of perceived quality is very high.

### INDUSTRIAL APPLICABILITY

A support and/or a decorative assembly according to the present invention, and its manufacture, are industrially applicable.

It is understood that various modifications and/or improvements that are obvious to a person skilled in the art can be applied to the various embodiments of the invention described in the present description, without going beyond the scope of the invention.

In particular, it can be noted that the mount 24 is provided so as to benefit from support over the entire circumference or periphery of the decorative insert 10. However, the mount 24 could also have portions without support, so as to have portions of partial support around the circumference of the decorative insert 10.

Preferably, the bezel crimping is provided on the entire circumference or periphery of the decorative insert 10. However, the portion to be crimped 25 could comprise portions without a lip, so as to obtain a partially bezel crimp or a bezel crimp only on certain portions of the circumference of the stone. Alternatively or in addition, it is possible to have deformable portions to be crimped, for example in the form of petals.

The crimping interface 125 of the crimping tool 120 could comprise recesses, clear spaces or portions outside the mount of the portion to be crimped 25, such that the crimping interface 125 only folds down on certain parts of the portion to be crimped 25 and to obtain a partially bezel crimp or a bezel crimp on only certain portions of the circumference of the decorative insert 10.

The support 20 may not include a machined portion to be crimped 25. Consequently, the decorative insert 10 could be crimped to the support 20 by a displacement of material by work hardening around of the stone, or by a lip sheared by the crimping tool 120 during crimping.

The inner clear space 127 of the crimping tool 120 could participate in the positioning of the decorative insert 10 during crimping, by guiding it by a contact with the pavilion 13. The guiding by the pavilion would comprise an additional means, for example a guiding means or a contact interface having a degree of freedom in the axial direction relative to the crimping tool 120.

The inner clear space 127 could incorporate and match the geometry of the pavilion 13 so as to angularly orient the decorative insert 10 during crimping.

The angular orientation of the decorative insert 10 facing the support 20 could be controlled or assisted by a display means. In the case where an angular orientation is to be ensured between the support 20 and the decorative insert 10, it is possible to take advantage of the mount 24 or the portion to be crimped 25 in order to ensure the angular orientation of the decorative insert 10, for example by providing a counter shape at the mount 24 or the portion to be crimped 25 which matches an outer contour of the decorative insert 10.

The decorative insert 10 could be housed or carried by the crimping tool 120 such that, during crimping, the latter can insert the decorative insert 10 into the through housing 21 of the support 20 and crimp it in a single action. To do this, the crimping tool 120 could comprise a gripping or holding means of the decorative insert 10.

The crimping could be carried out by a relative movement of the crimping tool 120 facing the support 20 or vice-versa, from top to bottom or from bottom to top. During this relative movement, the decorative insert 10 can be carried and put in place within the support 20 by the crimping tool 120 during the crimping.

Of course, a support 20 could comprise a plurality of housings 21 in order to be able to receive a plurality of decorative inserts 10. The case where the decorative insert 10 is crimped “upside down” can also be noted. In other words, the pavilion 13 of the decorative insert 10 would be positioned against the mount 24 and the portion to be crimped 25 would match the crown 12. Consequently, it would thus be the pavilion 13 which would be the visible side of the decorative assembly.

It is also possible to manufacture the decorative assembly using a method which provides a positioning of the support by coating or temporary overmoulding. For example, a plurality of supports 20 can be machined in a same metal plate, by starting at the front face 22 and accessible parts of the through housing 21. Once the front faces are formed and released, they can be embedded in a synthetic material which forms a coating or a protective envelope around the blanks of the supports 20. Then, the rear face 23 as well as the remainder of the through housing 21 (in particular the mount 24 and the portion to be crimped 25) can be machined. The machining of the rear face 23 may require turning the plate over in order to gain access. Since the front face is still embedded in the synthetic material, crimping can be carried out from the rear face, by relying on the synthetic material, which further reduces the risk of inadvertent marking of the front face 22 (the latter being embedded in and protected by the synthetic material). Once the crimping is performed, it is possible to remove the synthetic material (by dissolving, for example) and release the finished supports 20.

1. A support for a timepiece or item of jewellery, the timepiece or item of jewellery comprising the support and a decorative insert, such as a gemstone, crimped on the support, the support comprising:
a front face, arranged to be visible for a user,
a rear face,
at least one through housing arranged between the front face and the rear face and intended to receive the decorative insert, comprising:
an exposure opening provided on the front face in order to make the decorative insert visible to the observer,
an insertion opening provided on the rear face in order to introduce the decorative insert into the through housing,
a mount intended for positioning the decorative insert in the through housing,
characterised in that the support comprises a portion to be crimped intended to be plastically deformed on the decorative insert positioned against the mount, in order to produce a crimp of the decorative insert.

2. The support according to claim 1, comprising a bearing surface arranged on the rear face and intended to provide an end-of-crimping bearing for a crimping tool intended to deform the portion to be crimped on the decorative insert.

3. The support according to claim 2, wherein the bearing surface is arranged at the periphery of the portion to be crimped, and preferably around the portion to be crimped.

4. The support according to claim 2, wherein the portion to be crimped comprises a lip comprising a preferably cylindrical central face, and a preferably conical or frustoconical outer face, adjacent to the bearing surface.

5. The support according to claim 1, wherein the front face comprises a decorated surface intended to be visible for the user and comprising a decorative finish or a decorative termination such as a surface coating, diamond plating, polishing, or engraving.

6. The support according to claim 5, wherein, in a crimping direction and in a plane normal to the crimping direction:
the bearing surface has a first projected surface,
the front face has a second projected surface,
and wherein the area of the second projected surface is greater than the area of the first projected surface, preferably the area of the second projected surface is greater than 150% of the value of the area of the first projected surface, and preferably the area of the second projected surface is greater than 200% of the value of the area of the first projected surface.

7. The support according to claim 1, wherein the crimp of the decorative insert is a bezel crimp.

8. The support according to claim 1, wherein the portion to be crimped comprises a lip arranged at the periphery of the mount, and preferably around the mount, and intended to be completely or partially folded down on the decorative insert.

9. The support according to claim 1, wherein the portion to be crimped comprises at least one part of the side wall of the through housing to be pushed back and/or sheared by the crimping tool.

10. The support according to claim 1, wherein the mount comprises a contact surface with the decorative insert which is continuous.

11. The support according to claim 1, wherein the mount comprises a discontinuous contact surface with the decorative insert.

12. A timepiece or item of jewellery, comprising:
at least one support according to claim 1, and
at least one decorative insert arranged in the through housing against the mount, the portion to be crimped being crimped on the decorative insert.

13. A method for manufacturing a timepiece or item of jewellery, comprising the following steps:
providing a support according to claim 1,
introducing a decorative insert into the through housing via the insertion opening,
plastically deforming the portion to be crimped against the decorative insert.

14. The manufacturing method according to claim 13, wherein the step of plastically deforming the portion to be crimped is carried out in a single action and/or a single movement, by introducing a crimping tool into the through housing via the insertion opening, the crimping tool comprising a crimping interface intended to come into contact with the portion to be crimped and to plastically, and preferably simultaneously, deform the circumference of the portion to be crimped.

15. The manufacturing method according to claim 14, wherein the step of plastically deforming the portion to be crimped ends with a mechanical abutment of the crimping tool on the support.

16. The manufacturing method according to claim 14, the crimping tool comprising a contact interface intended to cooperate with the decorative insert, and wherein the manufacturing method comprises a step consisting of positioning the decorative insert relative to the support with the contact interface, at least before or during the step of plastic deformation of the portion to be crimped.

17. The manufacturing method according to claim 13, wherein the crimping tool follows a linear movement, preferably coaxial to an axial direction of the through housing.

18. A crimping tooling, provided for implementing the manufacturing method according to claim 13, comprising:
a crimping holder intended to receive the support,
a crimping tool comprising:
a crimping interface intended to come into contact with the portion to be crimped of the support and to plastically deform the portion to be crimped,
a contact interface, movable relative to the crimping interface and intended to receive and hold the decorative insert on the crimping tool before a crimping operation,
wherein the crimping tool has an internal clear space intended to avoid any direct contact between the crimping interface of the crimping tool and the decorative insert.
